(19) United States
(12) Patent Application Publication
(10) Pub. No.: US 2008/0270638 A1
(43) Pub. Date: Oct. 30, 2008

(54) SYSTEMS AND METHODS FOR MONITORING HIGH SPEED NETWORK TRAFFIC VIA SIMULTANEOUSLY MULTIPLEXED DATA STREAMS

(75) Inventors: Katherine T. Blinick, Tucson, AZ (US); Gregg S. Lucas, Tucson, AZ (US); Robert E. Medlin, Tucson, AZ (US); Gordon L. Washburn, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/741,793

(22) Filed: Apr. 30, 2007

(51) Int. Cl. G06F 3/00

(52) U.S. Cl. 710/12; 710/8

(57) ABSTRACT

Systems and methods for monitoring high-speed network traffic via simultaneously multiplexed data streams. Exemplary embodiments include a switch module system, including a first switch module coupled to a first server chassis, a first data port disposed on the first switch module and a set of data links disposed on the first data port, each data link configurable to receive a normal data stream and a monitored data stream.

### TRADEMARKS

IBM® and BladeCenter® are registered trademarks of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to storage network systems, and particularly to systems and methods for monitoring high-speed network traffic via simultaneously multiplexed data streams.

2. Description of Background

In storage network systems that have internalized high-speed fabrics, a high-speed switch is used to provide connectivity amongst individual servers and associated storage. In addition, such network storage systems can include multiple high-speed fabrics (1× and 4×). High-speed differential signaling is used to provide high bandwidth connections between a central serial attached SCSI (SAS) switch and other endpoints such as other switches or downstream or upstream storage components. SAS Switches can support multiple configurations, and several topologies, such as 16 external SAS ports, which can be “wide” or “narrow”. A wide port is comprised of multiple 1× links (e.g., PHYs) such as a 4×, 8×, 12×, etc., wide port.

In such systems, much of the storage area network (SAN) is internalized, wherein the server blades and the switch modules are coupled to one another via internal fabric. Such internalization can create problems that require access to pertinent data for problem detection, analysis and fault isolation. In some SAN systems, test equipment (e.g., a logic analyzer) can be inserted or onto a suspected high-speed interface such as the external fiber channel and capture pertinent data for problem resolution. However, when high-speed fabrics are internalized, it becomes difficult to access the fabric for troubleshooting problems. Although solutions, such as creating software trace events in microcode and directing error messages to a debug port, have been implemented, such solutions have shortcomings, including inaccurate detail of the failure, non real-time reporting of the failure, and resultant numerous iterations of adding a debug patch to isolate the problem. Other more invasive methods can include adding wires to a card to allow internal probing. This hardware-type approach is invasive to the system, limiting its analysis capability, and can cause potential corruption of the monitored data. In other instances, permanent electrical damage to the probed fabric circuitry can result. Although many of these approaches can be implemented in a controlled laboratory setting, these approaches are unsuitable for a customer environment. Therefore, there exists a need for systems and methods to troubles-hoot internalized high-speed fabric networks in a customer environment.

### BRIEF SUMMARY

Exemplary embodiments include a switch module system, including a first switch module coupled to a first server chassis, a first data port disposed on the first switch module and a set of data links disposed on the first data port, each data link configurable to receive a normal data stream and a monitored data stream.

Additional embodiments include a computer-readable medium having computer-executable instructions for performing a method, including configuring a multi-chassis system configured to support a server and a switch module to run data streams for the server and over the switch module, detecting a data failure on at least one data link coupled to the switch module, determining a data stream rate on the data link and configuring the data link to support a normal data stream and a monitored data stream on the data link.

Further embodiments include a switch module data monitoring method, including configuring a multi-chassis system to run data streams over a switch module interconnecting the multi-chassis system, detecting a data failure on at least one data link coupled to the switch module, determining a data stream rate on the data link, the data stream rate being at least one of 3 Gbit/s and 6 Gbit/s and configuring the data link to support a normal data stream and a monitored data stream on the data link configured at a rate of 6 Gbit/s, wherein the normal data stream and the monitored data stream are time multiplexed as a single data stream on the data link.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### TECHNICAL EFFECTS

As a result of the summarized invention, real-time tracing and troubleshooting of internal high speed fabric problems in a system configuration where all external SAS links are consumed running normal SAS I/O is achieved.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example of a prior art SAS storage network having two multi-chassis networks, each having fourteen blade servers;

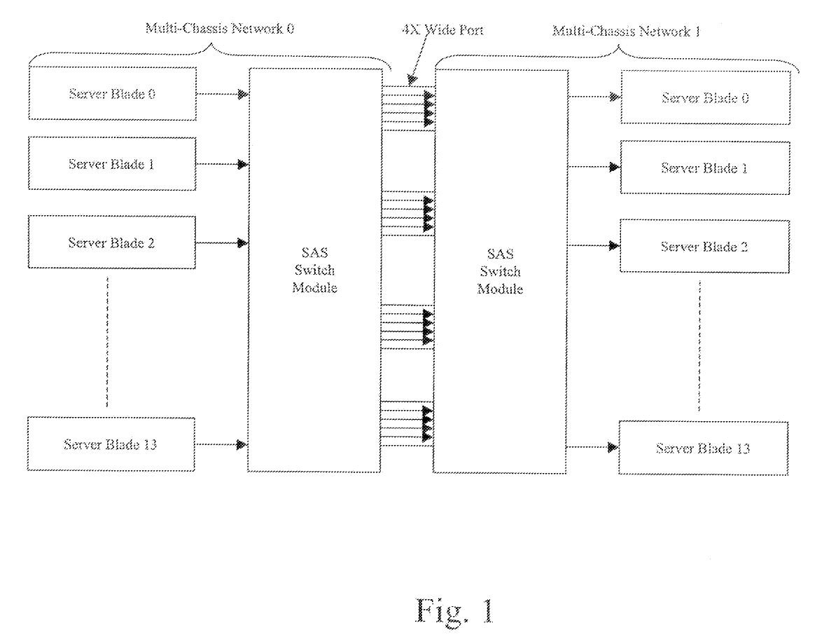

FIG. 2 illustrates one example of a SAS storage network system configured in accordance with exemplary embodiments;

FIG. 3 illustrates the example of the SAS storage network system of FIG. 2 configured in accordance with exemplary embodiments; and

FIG. 4 illustrates a flow chart of an exemplary method for monitoring high-speed network traffic via simultaneously multiplexed data streams.

The detailed description explains the preferred embodiments of the invention, together with advantages and features, by way of example with reference to the drawings.

### DETAILED DESCRIPTION

Exemplary embodiments include multi-chassis network systems that implement time multiplexing of multiple SAS I/O streams to monitor I/O data. An external SAS port can be configured for multiplexing one I/O stream and one monitored (or “snooped”) stream on a shared SAS link (e.g., a PHY). In an exemplary implementation, a 6 Gbit/s link is used to run two 3 Gbit/s streams implementing time multiplexing. As such, one stream can be SAS I/O data running at 3 Gbit/s, while the second stream can be the data of interest to be traced, running at 3 Gbit/s,

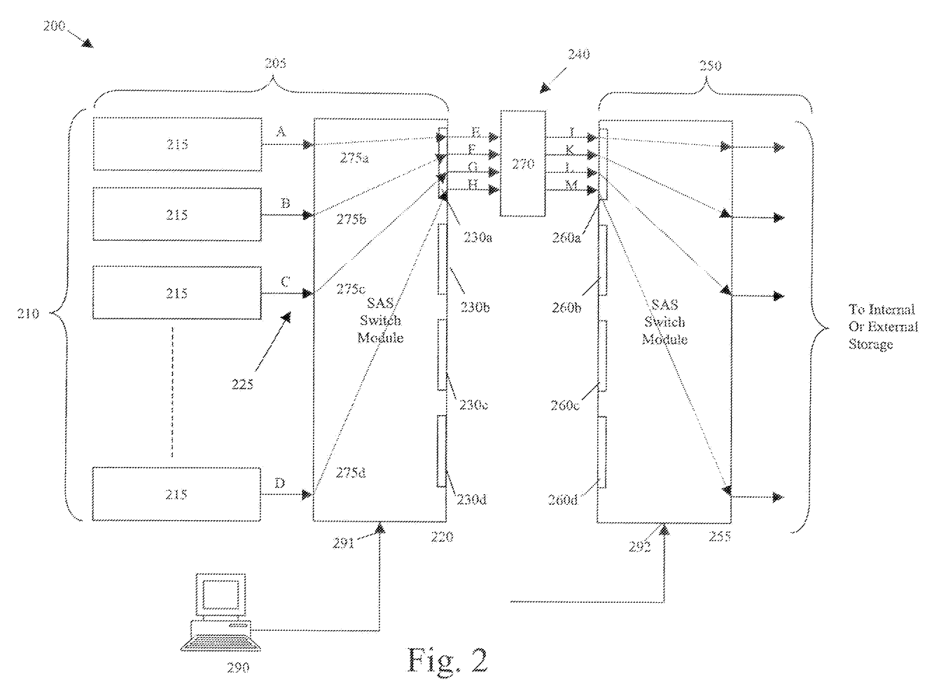

FIG. 2 illustrates one example of a SAS storage network system 200 configured in accordance with exemplary embodiments. The system 200 can include a first chassis network 205 having a first chassis 210 with multiple independent servers 215 (i.e., server blades), each independent server 215 having, among other things, a blade controller and an I/O controller. The first chassis 210 is coupled to and in communication with a first switch module 220. The first chassis 210 is coupled to the first switch module 220 through internal fabric 225, which can be single links A, B, C, D (e.g., 1×) between each independent server 215 and an input of the first switch module 220. The first switch module 220, which can be a SAS switch module, can, among other things, route and switch network data traffic to external fabric 240 via various wide ports 230a, 230b, 230c, 230d and/or individual data links, such as links E, F, G, H in the example shown in FIG. 2, a single wide port 230a is illustrated having four individual links E, F, G, H, thereby forming a 4× wide port, that is, wide port 230a. It is understood and appreciated that in other embodiments, the external fabric 240 can support any combination of data links and wide ports, such as but not limited to multiple single 1× links or other wide port configurations, including but not limited to 8×, 12×, 16×, etc. It is further appreciated that first switch module 220 is routing data streams 275a, 275b, 275c, 275d from, independent servers 215 to external fabric 240.

The system 200 further includes a second chassis network 250, having a second switch module 255, having wide ports 260a, 260b, 260c, 260d and data links J, K, L, M, and coupled to the first switch module 220 via the external fabric 240. It is appreciated that the external fabric 240, which can be a fiber cable, Ethernet Cable, SCSI cable, etc., is the medium that couples the wide ports 230, 260, and or individual links E, F, G, H, J, K, L, M to one another. The second switch module 255 can be coupled to and in communication with other internal or external storage such as, but not limited to, a second network chassis, a switch bunch of disks (SBOD), etc. It is further appreciated that any number of additional chassis networks, or other storage network media can be coupled to and in communication with the first and second chassis networks 205, 250 either upstream or downstream.

In general, high-speed switch technology provides the ability to selectively and redundantly mirror high-speed traffic to ports (e.g., wide ports, individual data links, etc.) on the same switch. For example, one or more of the wide ports 230a, 230b, 230c, 230d (or individual data links E, F, G, H) on first switch module 220 can be configured to monitor the other wide ports 230a, 230b, 230c, 230d (or individual data links E, F, G, H) on the first switch module 220. Such use of the wide ports 230a, 230b, 230c, 230d and/or data links E, F, G, H is now described in accordance with exemplary embodiments. This monitoring feature is also known as “snooping”, that is, high-speed traffic in progress through, for example, the first switch module 220 can be “snooped” or monitored and then directed to yet another port on the first switch module 220, that is, the port being dedicated for snooping. It is appreciated that, in order to have a snooping port or link, the first switch module 220 has available ports or links for snooping. In the system 200 illustrated in FIG. 2, all external switch ports can be used for SAS I/O traffic. In an exemplary embodiment, each data link, such as data links E, F, G, H, support 6 Gbit/s data traffic as well as 6 Gbit/s multiplexing. As such, time multiplexing of two 3 Gbit/s data streams (i.e., data transfers) can be supported onto a single 6 Gbit/s data link. Therefore, it is appreciated that 2× performance throughput can be realized when a fundamental SAS system, such as system 200 operates at 3 Gbit/s. As such, in the present example, the first switch module 220 supports the 6 Gbit/s capability, while the independent servers 215 are generally 3 Gbit/s capable. In an exemplary implementation, the links E, F, G, H on the first switch module 220 can run at the 3 Gbit/s or 6 Gbit/s rate.

Referring still to FIG. 2, the links E, F, G, H which form the 4× wide port 230a of the first switch module 220 are coupled to a logic analyzer 270, which is further coupled to the links J, K, L, M of second switch module 255. It is appreciated that all wide ports 230a, 230b, 230c, 230d, 260a, 260d, 260c, 260d and all links E, F, G, H, J, K, L, M are 6 Gbit/s capable. As such, all wide ports 230a-230d, 260a-260d, and data links E-H, J-M may operate at a 3 Gbit/s or 6 Gbit/s signaling rate. It is thus further appreciated that FIG. 2 illustrates an example when the system 200 has experienced a data fault, in this case between the connection of link A and link E, as discussed further below, which is under analysis by the imposition of the logic analyzer 270 within fabric 240. In this example, “normal” data traffic is routed from internal fabric data links A-D to external fabric data links E-H, respectively, at a data rate of 3 Gbit/s, as shown by arrows 275a, 275b, 275c, 275d. The data traffic further flows from the first switch module 220 to the second switch module 255 from data links E-H to data links J-M, respectively, through the logic analyzer 270.

System 200 further includes the capability to connect an external computing device 290, such as a laptop computer to a debug port 291, 292 on the first and second switch modules 220, 255. The external computing device 290 can configure the ports 230a-230d, 260a-260d and data links E-H, J-M to support the different data rates 3 Gbit/s and 6 Gbit/s as well as port/link mapping as further discussed below.

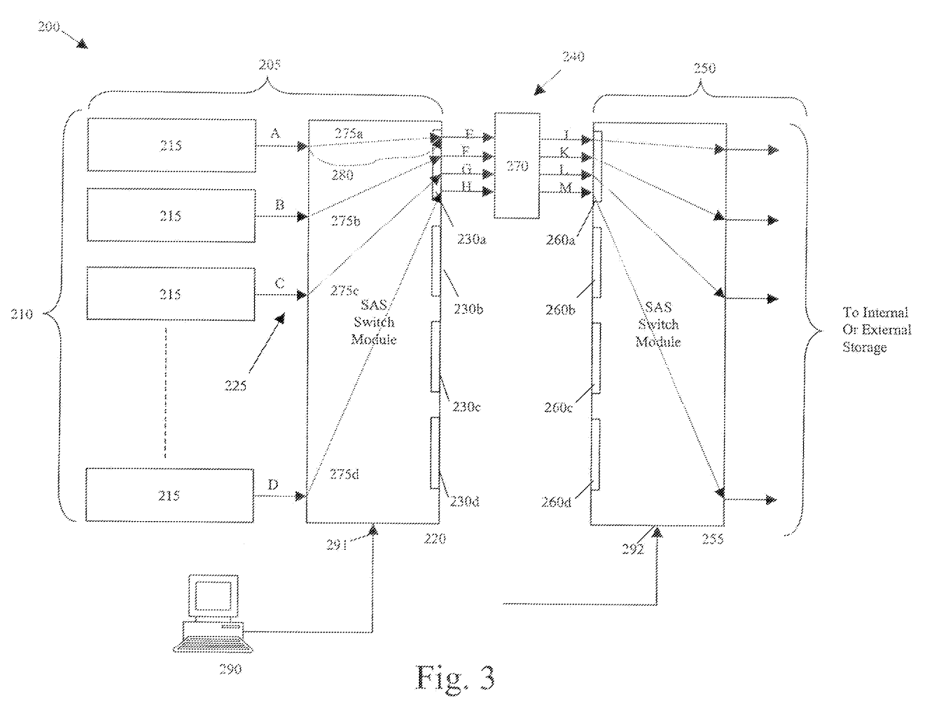

FIG. 3 illustrates the example of SAS storage network system 200 of FIG. 2 configured in accordance with exemplary embodiments. As described above, the ports 230a-230d and the data links E-H can be configured at the 3 Gbit/s rate. When the ports 230a-230d and /or the links E-H are configured and running at 3 Gbit/s rate, one of the wide ports 230a can be assigned as a special snoop port. In one exemplary implementation, the wide port 230a is configured to run at 6 Gbit/s rate, and to time multiplex two independent data streams. One stream 275a is the normal I/O traffic, generally from data link A, the other stream is a selectively mirrored stream 280 of data to be traced by the logic analyzer 270. It is thus appreciated that the logic analyzer 270 supports the 6 Gbit/s standard, and therefore, is able to interpret the multiplexed data streams 275a, 280. Both streams 275a, 280 are passed thru the logic analyzer 270 to the subsequent, second switch module 255, whereby the second snoop stream 280 is discarded. The second switch module 255 is thus is able to recover the original “normal I/O traffic” stream via link J and direct it to the target device.

It is appreciated that the external computing device 290 can include a process to configure the ports/links as needed. As such, in the example discussed in the preceding paragraph, if the wide port is already configured to and operating at 6 Gbit/s, then the external computing device 290 is used to configure (throttle) the links 275a-275d to run at the 3 Gbit/s rate. Furthermore, the external computing device is used to bypass the snooped data stream 280 from link A to link E, thereby bypassing the first switch module. As such, the multiplexed data stream 275a, 280 includes data from link A having passed through the first switch module 220, that is data stream 275a, and the data stream that has not passed through the first switch module, that is, snooped data stream 280, the aggregation of both links totaling the 6 Gbit/s link data rate. As discussed, these two data streams are time multiplexed and passed through links E, J and through the logic analyzer 270. It is therefore appreciated that the multiplexed data stream 275a, 280 can be used to analyze data faults as a result of passing through the first switch module 220. If there are differences in the data stream 275a, 280, then the user may conclude that there is a fault relating to the first switch module 220. If there is no difference between the data streams 275a, 280, then the user may conclude that the problem may be in one of the independent servers 215 of the chassis 210.

Referring still to FIG. 3, as discussed above, if links 275a-275d are configured to and operating at 3 Gbit/s, then the links 275a-275d can be reconfigured to operate at a rate of 6 Gbit/s. Under “normal” operating conditions, in which no data is being monitored, two normal 3 Gbit/s I/O data streams can be supported on the port configured to support 6 Gbit/s. When the ports 230a-230d are configured and running at 6 Gbit/s rate, one of the ports 230a-230d can be assigned as a special snoop port, similar to as discussed above. In an exemplary implementation, the selected snoop port remains configured to run at 6 Gbit/s rate and can time multiplex two independent data streams, similar to as discussed above. However, rather than multiplexing two normal I/O traffic streams, which can be any of the streams 275a-275d, only a single normal traffic I/O stream 275a, running at 3 Gbit/s, is allowed, while the second stream 280, running at 3 Gbit/s, is newly defined as a snoop stream 280, that is, a selectively mirrored stream of data to be traced by the logic analyzer 270. The logic analyzer 270 supports the 6 Gbit/s standard, therefore, it is able to interpret the multiplexed data streams 275a, 280. Both streams 275a, 280 are passed thru the logic analyzer 270 to the subsequent SAS Switch, that is, second switch module 255 whereby the second snoop stream 280 is discarded. The second switch module 255 is able to recover the original “normal I/O traffic” stream and direct it to the target device.

It is appreciated that the external computing device 290 can include a process to configure the ports/links as needed. As such, in the example discussed in the preceding paragraph, the external computing device 290 is used to configure the port 230a to run at the 6 Gbit/s rate. Furthermore, the external computing device is used to bypass the snooped data stream 280 from link A to link E, thereby bypassing the first switch module. As such, the multiplexed data stream 275a, 280 includes data from link A having passed through the first switch module 220, that is data stream 275a, and the data stream that has not passed through the first switch module, that is, snooped data stream 280.

As an example and referring still to FIG. 3, at some point link A traffic is transferring incorrect data causing an I/O failure. Similar to as discussed above, the problem could be incoming data from an independent server 215 in chassis 210 or data that is exiting the first switch module 220 on link E. Therefore, in order to isolate the fault, the stream 275a prior to entering first switch module 220 and after entering first switch module 220 are of interest to be captured by the logic analyzer 270. The normal outgoing traffic stream 275a already is routed to the logic analyzer 270. The additional incoming stream from link A is defined as a snoop stream 280 and also directed to link E by configuring link E to multiplex both 3 Gbit/s streams. As discussed, this configuration can be done in real time during normal operation of the system 200 without any disruptions.

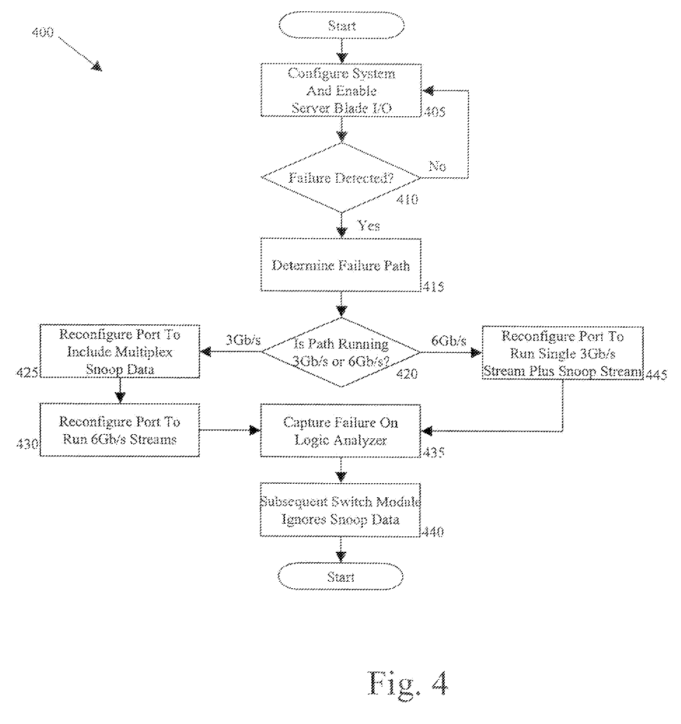

FIG. 4 illustrates a flow chart of an exemplary method 400 for monitoring high-speed network traffic via simultaneously multiplexed data streams. In accordance with exemplary embodiments, the system 200 is configured for operation and the independent server 215 I/O is configured at step 405. At step 410, it is determined whether or not a failure has occurred, which is generally a data fault failure as discussed above. If a failure is not detected at step 410, then operation continues at step 405. If a failure has occurred at step 410, then the failure path is determined at step 415. It is appreciated that a failure is detected and the failure path is determined by the presence of faulty data along a particular path. As discussed above, the failure path can be a data link. When the failure path is identified at step 415, the method 400 determines whether the path is running at 3 Gbit/s or 6 Gbit/s at step 420. As discussed above, if the data path is running at 3 Gbit/s at step 420, then the port is reconfigured to include multiplex snoop data at step 425. Then at step 430 the port is reconfigured to run at a 6 Gbit/s stream. At step 435 the failure is captured on the logic analyzer 270 as discussed above. At step 440, the snoop data stream 280 is ignored by the subsequent switch module, which can be second switch module 255.

If it is determined that the failure path is running at 6 Gbit/s at step 420, then at step 445, the port is reconfigured to run single 3 Gbit/s stream 275a plus the snoop data stream 280, which, is also running at 3 Gbit/s. At step 435 the failure is captured on the logic analyzer 270 as discussed above. At step 440, the snoop data stream 280 is ignored by the subsequent switch module, which can be second switch module 255. It is appreciated that the method 400 continues as data faults and failures occur.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A switch module system, comprising:
a first switch module coupled to a first server chassis;
a first data port disposed on the first switch module; and
a set of data links disposed on the first data port, each data link configurable to receive a normal data stream and a monitored data stream.

2. The system as claimed in claim 1 wherein each data link is further configured to support a 3 Gbit/sec data stream.

3. The system as configured in claim 2 wherein each data link is further configured to support 6 Gbit/sec data stream.

4. The system as claimed in claim 1 wherein the first data port comprises a subset of the data links.

5. The system as claimed in claim 4 wherein the first data port is a wide port.

6. The system as claimed in claim 1 wherein the normal data stream and the monitored data stream are time multiplexed on one of the data links.

7. The system as claimed in claim 6 wherein the time multiplexed data link supports the normal data stream running at 3 Gbit/s and the monitored data stream running at 3 Gbit/s.

8. The system as claimed in claim 7 wherein the time multiplexed data link is configured to run at a rate of 6 Gbit/s.

9. The system as claimed in claim 1 further comprising a logic analyzer disposed between the first switch module and a second switch module, the first data port for coupling to a second data lane disposed on a second switch module, the logic analyzer configured to monitor the monitored data stream running at 3 Gbit/s, the monitored data stream being multiplexed with the normal data stream running at 3 Gbit/s, the normal data stream and the monitored data stream, being time multiplexed on one of the data links that is configured to run at 6 Gbit/s.

10. A computer-readable medium having computer-executable instructions for performing a method, comprising:
configuring a multi-chassis system configured to support a server and a switch module to run data streams for the server and over the switch module;
detecting a data failure on at least one data link coupled to the switch module;
determining a data stream rate on the data link; and
configuring the data link to support a normal data stream and a monitored data stream on the data link.

11. The computer-readable medium as claimed in claim 10 wherein the method further comprises capturing the data failure on a logic analyzer.

12. The computer-readable medium as claimed in claim 11 wherein the method further comprises discarding the snooped data stream in a second switch module in response to an analysis of the monitored data stream by the logic analyzer.

13. The computer-readable medium as claimed in claim 10 wherein the data rate is 3 Gbit/s.

14. The computer-readable medium as claimed in claim 13 wherein the data link is reconfigured to include the normal data stream and the monitored data stream.

15. The computer-readable medium as claimed in claim 14 wherein the data link is reconfigured to run at a rate of 6 Gbit/s,

16. The computer-readable medium as claimed in claim 15 wherein the normal data stream and the monitored data stream run as a single 6 Gbit/s time multiplexed data stream, on the data link.

17. The computer-readable medium, as claimed in claim 10 wherein the data rate is 6 Gbit/s.

18. The computer-readable medium as claimed in claim 17 wherein the data link is reconfigured to run the normal data stream at a rate of 3 Gbit/s and the monitored data stream at a rate of 3 Gbit/s.

19. The computer-readable medium as claimed in claim 18 wherein the normal data stream and the monitored data stream run as a single 6 Gbit/s time multiplexed data stream on the data link.

20. A switch module data monitoring method, comprising:
configuring a multi-chassis system to run data streams over a switch module interconnecting the multi-chassis system;
detecting a data failure on at least one data link coupled to the switch module;
determining a data stream rate on the data link, the data stream rate being at least one of 3 Gbit/s and 6 Gbit/s; and
configuring the data link to support a normal data stream and a monitored data stream on the data link configured at a rate of 6 Gbit/s, wherein the normal data stream and the monitored data stream are time multiplexed as a single data stream on the data link.
